(19) United States
(12) Patent Application Publication
(10) Pub. No.: US 2026/0322458 A1
(43) Pub. Date: Oct. 15, 2026

(54) INFORMATION TRANSCEIVING METHOD AND APPARATUS

(71) Applicant: 1FINITY Inc., Kawasaki-shi (JP)

(72) Inventors: Gang SUN, Beijing (CN); Xin WANG, Beijing (CN)

(73) Assignee: 1FINITY Inc., Kawasaki-shi (JP)

(21) Appl. No.: 19/342,948

(22) Filed: Sep. 29, 2025

Related U.S. Application Data
(63) Continuation of application No. PCT/CN2023/086608, filed on Apr. 6, 2023.

(51) Int. Cl. H04B 7/06; H04B 17/391; H04W 72/21; H04W 72/231; H04W 76/20

(52) U.S. Cl. CPC H04B 7/063; H04B 17/3913; H04W 72/21; H04W 72/231; H04W 76/20

(57) ABSTRACT

An information transceiving apparatus, applicable to a network device, includes: a first transmitter configured to transmit to a terminal equipment a quantization parameter of a report quantity; and a first receiver configured to receive a report quantity quantized by the terminal equipment according to the quantization parameter.

### CROSS-REFERENCE TO RELATED APPLICATION

This application is a continuation application under 35 U.S.C. 111(a) of International Patent Application PCT/CN2023/086608 filed on Apr. 6, 2023, and designated the U.S., the entire contents of which are incorporated herein by reference.

### TECHNICAL FIELD

This disclosure relates to the field of communication technologies.

### BACKGROUND

As low frequency band spectrum resources become scarce, a millimeter-wave frequency band can provide a greater bandwidth and becomes an important frequency band for a 5G NR (New Radio) system. Millimeter wave has different propagation characteristics from legacy low frequency bands due to its shorter wavelength, such as a higher propagation loss, poor reflection and diffraction performance, etc. Therefore, a larger-scale array of antennas will be usually used to form a shaped beam with a greater gain, which overcomes propagation losses and ensures system coverage. The 5G NR standard designs a series of schemes for beam management, such as beam scanning, beam measurement, beam reporting, and beam indication, etc. However, when the number of transceiving beams is relatively large, the payload and latency of a system will be greatly increased.

With the development of Artificial Intelligence (AI) technology, it has become a current technical direction to apply the Artificial Intelligence technology to a physical layer of wireless communication, so as to solve the difficulties of legacy methods. For beam management, using an AI model to predict spatially optimal beam pairs based on a result of a small number of beam measurements can greatly reduce the payload and latency of the system.

It should be noted that the above introduction to the technical background is just to facilitate a clear and complete description of the technical solutions of the present disclosure, and is elaborated to facilitate understanding of persons skilled in the art. It cannot be considered that these technical solutions are known by persons skilled in the art just because these solutions are elaborated in the Background of the present disclosure.

### SUMMARY

It is assumed that a transmitting side of a communication system has M beams and a receiving side has N beams. In the existing standards, M*N beams need to be measured. When the number of M and N is relatively large, measuring the M*N beams will lead to a relatively larger system payload and a relatively longer latency. Using a model (e.g., an AI model) to predict an optimal beam pair from measurement results of a small number of beams can greatly reduce the system payload and latency caused by beam measurements.

In existing beam measurement reporting, a measurement result needs to be quantized before being reported. Two quantization modes are adopted in existing standards, i.e., absolute quantization and differential quantization. Absolute quantization refers to direct quantization of a measurement value, for example, using a fixed 7-bit to quantize the measurement value, with a quantization range from −140 to −44 dBm and a quantization step being 1 dB. Differential quantization refers to: by taking a maximum measurement value in the reporting instance as a benchmark, calculating a difference value between a measurement value required to be reported and the benchmark, quantizing the difference value with 4 bits, its quantization step is 2 dB. However, the inventor finds that quantization parameters of the two quantization modes in the existing standards are both fixed in the standards, and the quantization modes are not flexible enough.

For at least one of the above problems, the embodiments of the present disclosure provide an information transceiving method and apparatus.

According to one aspect of embodiments of the present disclosure, an information transceiving apparatus is provided, applicable to a network device, the apparatus including:
a first transmitting unit configured to transmit to a terminal equipment a quantization parameter of a report quantity; and
a first receiving unit configured to receive a quantized report quantity by the terminal equipment according to the quantization parameter.

According to another aspect of the embodiments of the present disclosure, an information transceiving apparatus is provided, applicable to a terminal equipment, the apparatus including:
a second receiving unit configured to receive a quantization parameter of a report quantity transmitted by a network device;
a first processing unit configured to quantize the report quantity according to the quantization parameter; and
a second transmitting unit configured to transmit a quantized report quantity to the network device.

According to another aspect of the embodiments of the present disclosure, an information transceiving apparatus is provided, applicable to a terminal equipment, the apparatus including:
a second processing unit configured to quantize a report quantity according to a quantization parameter predefined for an AI model using phase or for an AI model or for a type of the report quantity, wherein quantization parameters of report quantities to which different types of report quantities and/or different AI model using phases and/or different AI models correspond are identical or different; and
a third transmitting unit configured to transmit a quantized report quantity to a network device.

According to a further aspect of the embodiments of the present disclosure, a communication system is provided, including a terminal equipment and/or a network device, the terminal equipment including an information transceiving apparatus in the above-mentioned another aspect, and the network device including an information transceiving apparatus in the above-mentioned one aspect.

One of advantageous effects of the embodiments of the present disclosure lies in: a network device configures a quantization parameter of a report quantity for a terminal equipment, thereby the terminal equipment is capable of quantizing the report quantity according to the quantization parameter, this quantization scheme is more flexible, i.e., can not only ensure the performance of an AI model but also can reduce a payload of an uplink.

One of advantageous effects of the embodiments of the present disclosure lies in: a terminal equipment is capable of quantizing report quantity according to a predefined quantization parameter, quantization parameters of report quantities to which different types of report quantities and/or different AI model using phases and/or different AI models correspond are identical or different, this quantization scheme is more flexible, i.e., can not only ensure the performance of an AI model but also can reduce a payload of an uplink.

Referring to the later description and drawings, specific implementations of the present disclosure are disclosed in detail, indicating a mode that the principle of the present disclosure may be adopted. It should be understood that the implementations of the present disclosure are not limited in terms of a scope. Within the scope of the spirit and terms of the attached claims, the implementations of the present disclosure include many changes, modifications and equivalents.

Features that are described and/or shown for one implementation may be used in the same way or in a similar way in one or more other implementations, may be combined with or replace features in the other implementations.

It should be emphasized that the term “comprise/include” when being used herein refers to presence of a feature, a whole piece, a step or a component, but does not exclude presence or addition of one or more other features, whole pieces, steps or components.

### BRIEF DESCRIPTION OF THE DRAWINGS

Elements and features depicted in a drawing or an implementation of the embodiments of the present disclosure may be combined with an element and a feature shown in one or more other drawings or implementations. In addition, in the drawings, like reference numerals designate corresponding parts throughout the several views and may be used to designate like or similar parts in more than one embodiment.

FIG. 1 is a schematic diagram of a communication system of the present disclosure;

FIG. 2 is a schematic diagram of a transmitting beam and a receiving beam in a communication system of the embodiments of the present disclosure;

FIG. 3 is a schematic diagram of an information transceiving method in the embodiments of the present disclosure;

FIG. 4 is a schematic diagram of an information transceiving method in the embodiments of the present disclosure;

FIG. 5 is a schematic diagram of an information transceiving method in the embodiments of the present disclosure;

FIG. 6 is a schematic diagram of an information transceiving method in the embodiments of the present disclosure;

FIG. 7 is a schematic diagram of an information transceiving method in the embodiments of the present disclosure;

FIG. 8 is a schematic diagram of an information transceiving method in the embodiments of the present disclosure;

FIG. 9 is a schematic diagram of an information transceiving method in the embodiments of the present disclosure;

FIG. 10 is a schematic diagram of an information transceiving method in the embodiments of the present disclosure;

FIG. 11 is a schematic diagram of an information transceiving method in the embodiments of the present disclosure;

FIG. 12 is a schematic diagram of an information transceiving apparatus in the embodiments of the present disclosure;

FIG. 13 is a schematic diagram of an information transceiving apparatus in the embodiments of the present disclosure;

FIG. 14 is a schematic diagram of an information transceiving apparatus in the embodiments of the present disclosure;

FIG. 15 is a schematic diagram of a network device in the embodiments of the present disclosure;

FIG. 16 is a schematic diagram of a terminal equipment in the embodiments of the present disclosure.

### DETAILED DESCRIPTION

Referring to the drawings, through the following Specification, the aforementioned and other features of the present disclosure will become obvious. The Specification and the drawings specifically disclose particular implementations of the present disclosure, showing partial implementations which may adopt the principle of the present disclosure. It should be understood that the present disclosure is not limited to the described implementations, on the contrary, the present disclosure includes all the modifications, variations and equivalents falling within the scope of the attached claims.

In the embodiments of the present disclosure, the term “first” and “second”, etc. are used to distinguish different elements in terms of appellation, but do not represent a spatial arrangement or time sequence, etc. of these elements, and these elements should not be limited by these terms. The term “and/or” includes any and all combinations of one or more of the associated listed terms. The terms “include”, “comprise” and “have”, etc. refer to the presence of stated features, elements, members or components, but do not preclude the presence or addition of one or more other features, elements, members or components.

In the embodiments of the present disclosure, the singular forms “a/an” and “the”, etc. include plural forms, and should be understood broadly as “a kind of” or “a type of”, but are not defined as the meaning of “one”; in addition, the term “the” should be understood to include both the singular forms and the plural forms, unless the context clearly indicates otherwise. In addition, the term “according to” should be understood as “at least partially according to . . . ”, the term “based on” should be understood as “at least partially based on . . . ”, unless the context clearly indicates otherwise.

In the embodiments of the present disclosure, the term “a communication network” or “a wireless communication network” may refer to a network that meets any of the following communication standards, such as Long Term Evolution (LTE), LTE-Advanced (LTE-A), Wideband Code Division Multiple Access (WCDMA), High-Speed Packet Access (HSPA) and so on.

And, communication between devices in a communication system may be carried out according to a communication protocol at any stage, for example may include but be not limited to the following communication protocols: 1G (generation), 2G, 2.5G, 2.75G, 3G, 4G, 4.5G, and 5G, New Radio (NR), future 6G and so on, and/or other communication protocols that are currently known or will be developed in the future.

In the embodiments of the present disclosure, the term “a network device” refers to, for example, a device that accesses a terminal equipment in a communication system to a communication network and provides services to the terminal equipment. The network device may include but be not limited to the following devices: a Base Station (BS), an Access Point (AP), a Transmission Reception Point (TRP), a broadcast transmitter, a Mobile Management Entity (MME), a gateway, a server, a Radio Network Controller (RNC), a Base Station Controller (BSC) and so on.

The base station may include but be not limited to: node B (NodeB or NB), evolution node B (eNodeB or eNB) and a 5G base station (gNB), etc., and may further includes Remote Radio Head (RRH), Remote Radio Unit (RRU), a relay or a low power node (such as femeto, pico, etc.). And the term “base station” may include their some or all functions, each base station may provide communication coverage to a specific geographic region. The term “cell” may refer to a BS and/or its coverage area, which depends on the context in which this term is used.

In the embodiments of the present disclosure, the term “User Equipment (UE)” or “Terminal Equipment (TE) or Terminal Device” refers to, for example, a device that accesses a communication network and receives network services through a network device. The terminal equipment may be fixed or mobile, and may also be referred to as Mobile Station (MS), a terminal, Subscriber Station (SS), Access Terminal (AT) and a station and so on.

The terminal equipment may include but be not limited to the following devices: a Cellular Phone, a Personal Digital Assistant (PDA), a wireless modem, a wireless communication device, a handheld device, a machine-type communication device, a laptop computer, a cordless phone, a smart phone, a smart watch, a digital camera and so on.

For another example, under a scenario such as Internet of Things (IoT), the terminal equipment may also be a machine or apparatus for monitoring or measurement, for example may include but be not limited to: a Machine Type Communication (MTC) terminal, a vehicle-mounted communication terminal, a Device to Device (D2D) terminal, a Machine to Machine (M2M) terminal and so on.

Moreover, the term “a network side” or “a network device side” refers to a side of a network, may be a base station, and may include one or more network devices as described above. The term “a user side” or “a terminal side” or “a terminal equipment side” refers to a side of a user or terminal, may be a UE, and may include one or more terminal equipments as described above. If it is not specifically mentioned herein, “a device” may refer to a network device, or may refer to a terminal equipment.

In the following description, without causing confusion, the terms “uplink control signal” and “Uplink Control Information (UCI)” or “Physical Uplink Control Channel (PUCCH)” are interchangeable, and the terms “uplink data signal” and “uplink data information” or “Physical Uplink Shared Channel (PUSCH)” are interchangeable.

The terms “downlink control signal” and “Downlink Control Information (DCI)” or “Physical Downlink Control Channel (PDCCH)” are interchangeable, and the terms “downlink data signal” and “downlink data information” or “Physical Downlink Shared Channel (PDSCH)” are interchangeable.

Moreover, transmitting or receiving a PUSCH can be understood as transmitting or receiving uplink data carried by the PUSCH, transmitting or receiving a PUCCH can be understood as transmitting or receiving uplink information carried by the PUCCH, transmitting or receiving a PRACH can be understood as transmitting or receiving a preamble carried by the PRACH; an uplink signal may include an uplink data signal and/or an uplink control signal, etc., or may also be referred to as UL transmission or uplink information or uplink channel. Transmitting an uplink transmission on an uplink resource can be understood as transmitting the uplink transmission by using the uplink resource. Similarly, downlink data/signals/channels/information may be understood accordingly.

In the embodiments of the present disclosure, higher layer signaling may be e.g. radio resource control (RRC) signaling; for example, is called an RRC message, for example includes an MIB, system information, and a dedicated RRC message; or is called an RRC information element (RRC IE). The higher layer signaling, for example, may further be Medium Access Control (MAC) signaling; or called a MAC control element (MAC CE). However, the present disclosure is not limited to this.

Scenarios of the embodiments of the present disclosure are described through the following examples, however the present disclosure is not limited to these.

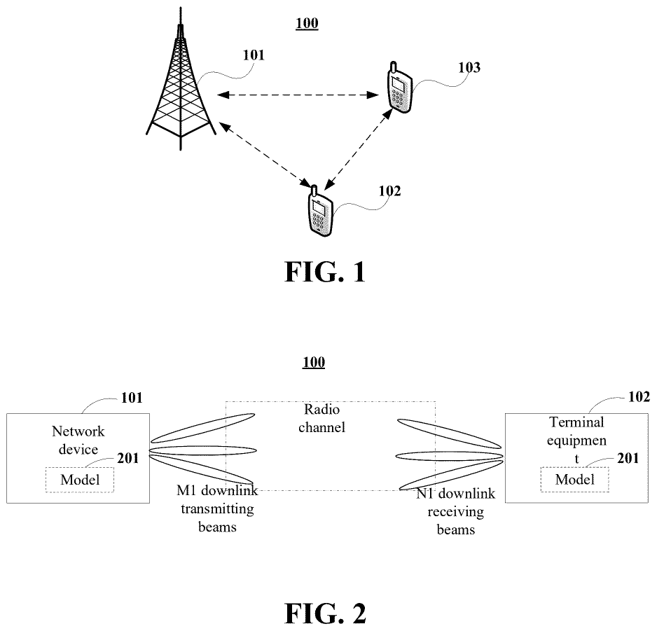

FIG. 1 is a schematic diagram of a communication system in the embodiments of the present disclosure, schematically describes situations by taking a terminal equipment and a network device as examples, as shown in FIG. 1, a communication system 100 may include a network device 101 and terminal equipments 102, 103. For simplicity, FIG. 1 only takes two terminal equipments and one network device as examples for description, however the embodiments of the present disclosure are not limited to this.

In the embodiments of the present disclosure, transmission of existing or further implementable services may be carried out between the network device 101 and the terminal equipments 102, 103. For example, these services may include but be not limited to: enhanced Mobile Broadband (eMBB), massive Machine Type Communication (mMTC), Ultra-Reliable and Low-Latency Communication (URLLC) and so on.

The terminal equipment 102 may transmit data to the network device 101, for example, using a granted or ungranted transmission mode. The network device 101 may receive the data transmitted by one or more terminal equipments 102, and feed back information to the terminal equipment(s) 102, such as acknowledgment ACK/non-acknowledgment NACK information, etc., the terminal equipment(s) 102 may confirm ending a transmission process, or may further perform new data transmission, or may perform data retransmission, according to the feedback information.

It is worth noting that FIG. 1 shows that two terminal equipments 102 and 103 are within the coverage of network device 101, but the present disclosure is not limited to this. The two terminal equipments 102 and 103 may be outside the coverage of the network device 101, or one terminal equipment 102 may be within the coverage of the network device 101 and the other terminal equipment 103 may be outside the coverage of the network device 101.

The AI model (or ML model) includes but is not limited to: an input layer, a plurality of convolutional layers, a concat layer, a fully connected (FC) layer, and a quantizer, etc. Processing results of the plurality of convolutional layers are merged in the concat layer. For a specific structure of the AI model, existing technologies may be referred to, detailed description is omitted here.

FIG. 2 is a schematic diagram of transmitting beams and receiving beams in a communication system of the embodiments of the present disclosure. As shown in FIG. 2, in the communication system 100, by taking a downlink channel as an example, the network device 101 may have M1 downlink transmitting beams DL TX, and the terminal equipment 102 may have N1 downlink receiving beams DL RX.

In the embodiments of the present disclosure, as shown in FIG. 2, a model 201 for predicting a beam measurement result may be deployed in the network device 101 or the terminal equipment 102. The model 201 may predict measurement results of M1*N1 beams according to measurement results of partial beams. The model 201 e.g. may be an AI model.

In addition, for uplink channels, the network device 101 may have N2 uplink receiving beams (not shown in FIG. 2), and the terminal equipment 102 may have M2 uplink transmitting beams UL TX (not shown in FIG. 2).

The inventor finds that in legacy beam measurement reporting, a terminal equipment needs to report measurement results of its beams to a network device. The following Table 1 is a schematic diagram of an existing beam measurement reporting information format.

TABLE 1

| | |
|---|---|
| CSI report #n | SSBRI/CRI #1 |
| | SSBRI/CRI #2 |
| | SSBRI/CRI #3 |
| | SSBRI/CRI #4 |
| | RSRP #1 |
| | Differential RSRP #2 |
| | Differential RSRP #3 |
| | Differential RSRP #4 |

As shown in Table 1, the reporting information includes measured RSRP (Reference Signal Receiving Power) values #1, #2, #3, #4, and a synchronization signal block (SSB) resource indicator (SSB RI) associated with the measured RSRP or channel state information reference signal resource indicators (CSI-RS resource indicator, CRI) #1, #2, #3, #4. That is to say, the terminal equipment only reports 1 to 4 largest results in RSRPs measured by it to the network device. However, in a scheme of performing beam prediction based on AI/ML models, it includes inference, training (data collection), and model monitoring by using the AI model. For example, when training the AI model, the terminal equipment may need to report all beam measurement/prediction results to the network device. At this point, a dynamic range of results to be quantized is relatively large. Therefore, using a legacy quantization scheme will lead to reduction in the performance of beam prediction. At present, the standards do not define a quantization parameter respectively for different phases of the AI model.

For the above problem, the embodiments of the present disclosure provide an information transceiving method and apparatus, description is made below with reference to the drawings and the embodiments.

### Embodiments of a First Aspect

Embodiments of the present disclosure provide an information transceiving method, which is described from a network device side.

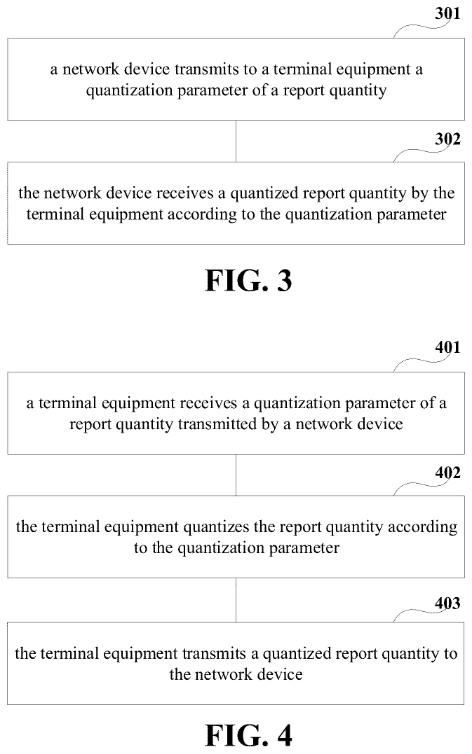

FIG. 3 is a schematic diagram of an information transceiving method in the embodiments of the present disclosure. As shown in FIG. 3, the method includes:
301, a network device transmits to a terminal equipment a quantization parameter of a report quantity; and
302, the network device receives a quantized report quantity by the terminal equipment according to the quantization parameter.

It should be noted that the above FIG. 3 only schematically describes the embodiments of the present disclosure, but the present disclosure is not limited thereto. For example, an execution step of each operation may be adjusted appropriately, moreover other some operations may be increased or reduced. Persons skilled in the art may make appropriate modifications according to the above contents, not limited to the records in the above FIG. 3.

In some embodiments, the report quantity in 301 is transmitted by the terminal equipment to the network device in an entire process of performing beam prediction based on an AI model. The AI model may be deployed at a network device side, or deployed at a terminal equipment side. The AI model may include a training phase (data collection phase), an inference phase, and a performance monitoring phase. The following text will first describe respectively different AI deployment positions and phases mentioned above, as well as the report quantity involved.

In some embodiments (1), the AI model may be deployed at a network device side, in an AI model training (data collection) phase (completed by the network device, the training includes online training or offline training or update), the terminal equipment needs to collect measurement results of all beams (or beam pairs) and needs to report all the measurement results to the network device. The network device uses all the measurement results as label data for AI model training, and input them into the AI model for training. Thus, in this scenario, the report quantity transmitted by the terminal equipment is all beams (or beam pairs) and corresponding measurement results, such as an L1-RSRP (Reference Signal Receiving Power) value or an L1-SINR (Signal to Interference plus Noise Ratio) value.

In some embodiments (2), the AI model may be deployed at a network device side, in an AI model inference (prediction) phase (completed by the network device), the terminal equipment needs to report measurement results of parts of beams (or beam pairs) (for example, several measurement results with larger measurement values, etc., the embodiments of the present disclosure do not use this as a limitation), and needs to report the parts of measurement results to the network device. The network device uses the parts of measurement results as input data for the AI model, inputs them into the AI model for inference, to obtain a prediction result, including each beam (or beam pair) and corresponding measurement predicted values. Thus, in this scenario, the report quantity transmitted by the terminal equipment is parts of beams (or beam pairs) and corresponding measurement results, such as an L1-RSRP (Reference Signal Receiving Power) value or an L1-SINR (Signal to Interference plus Noise Ratio) value.

In some embodiments (3), the AI model is deployed at a network device side, inputs of the AI model are measurement results of parts of beams (beams pairs), and outputs of the AI model may include each beam (or beam pair) and corresponding measurement predicted values. There may be an error between a predicted value and an actual measurement result, and the error may be used to evaluate the performance of the AI model is good or bad. Thus, in the AI model performance monitoring phase (completed by the network device), performance metrics related to the measured value L1-RSRP or L1-SINR, such as a prediction error of a beam measurement result (such as a difference between a predicted value and a measured value), may be used as a performance metric of the AI model performance monitoring phase. For a calculation mode for this prediction error, relevant technologies may be referred to, the embodiments of the present disclosure do not use this as a limitation. Thus, in this scenario, the report quantity transmitted by the terminal equipment is parts of beams (or beam pairs) or all beams (or beam pairs) and the corresponding measurement results, the measurement results are used to calculate the performance metric at the network device side in combination with a prediction result (obtained at the network side) to perform performance monitoring.

In some embodiments (4), the AI model is deployed at a terminal equipment side, but the AI model is trained at the network device side. Thus, in the AI model training phase, the report quantity of the terminal equipment is the same as that in a corresponding phase during which the AI model is deployed at the network device side, detailed description is omitted here.

In some embodiments (5), the AI model is deployed at a terminal equipment side, but the AI model performance is monitored at the network device side. Thus, in the AI model performance monitoring phase, the report quantity of the terminal equipment is the same as that in a corresponding phase during which the AI model is deployed at the network device side, detailed description is omitted here. In addition, the report quantity may further include a predicted value (obtained at a terminal side) and the corresponding beam, the network device may calculate a prediction error of beam measurement results (such as a difference between a predicted value and a measured value) as a performance metric of the AI model performance monitoring phase.

In some embodiments (6), the AI model is deployed at a terminal equipment side, in an AI model inference phase, the terminal equipment measures and obtains measurement results of parts of beams (or beam pairs) and inputs them into the AI model for inference to obtain a prediction result, including each beam (or beam pair) and corresponding measurement predicted values. Thus, in this scenario, the report quantity transmitted by the terminal equipment is predicted parts of beams (or beam pairs) and corresponding predicted results, such as one or more optimal predicted values.

In some embodiments (7), the AI model is deployed at a terminal equipment side, but when the AI model performance monitoring phase is at the terminal equipment side, the terminal equipment needs to determine a performance metric value (such as a prediction error) according to such as a predicted value and a measured value obtained in the inference phase, and report the performance metric value to the network device. The network device may determine whether it is necessary to switch the AI model or activate the AI model or deactivate the AI model according to the performance metric value. Thus, in this scenario, the report quantity transmitted by the terminal equipment is an AI model performance metric.

In the above scenarios (1) and (4), the terminal equipment not only needs to report measurement results with larger value, but also needs to report measurement results with smaller value. That is to say, the terminal equipment needs a larger dynamic range to quantize the measurement results, and reports a large number of results. In the above scenario (2), the terminal equipment only needs to report the measurement results of parts of beams (or beam pairs), and a dynamic range of the reported measurement values is approximately equal to or smaller than that in the training phase. In the above scenario (3), if the terminal equipment only needs to report parts of measurement results, a dynamic range of the required reported values is approximately equal to that of legacy beam reporting. If the terminal equipment needs to report all the measurement results, a dynamic range of the reported measurement values is approximately equal to that in the training phase. In the above scenario (6), the terminal equipment only reports parts of predicted values to the network device, and the dynamic range of the reported predicted values is approximately equal to that of legacy beam reporting. In the above scenario (5), the terminal equipment needs to report the measurement results corresponding to parts of beams (or beam pairs) or all beams (or beam pairs), and may also report some predicted values. Therefore, the dynamic range of the required reported values is approximately equal to that in scenario (3). In the above scenario (7), the terminal device reports performance metrics which are also different from the quantization accuracy of the measured value and of the predicted value or dynamic range.

As may be known from the above examples, different AI model using phases, or data volume, dynamic ranges, quantization accuracy requirements, etc. of different types of report quantities are different, thus quantization parameters may be configured for the different AI model using phases or different types of report quantities, thereby performance deterioration can be avoided, and an uplink payload can also be reduced at the same time. Quantization parameters of different types of report quantities are identical or different, and quantization parameters of report quantities to which different AI model using phases correspond are identical or different. The network device may configure corresponding quantization parameters for each AI model using phase (or each type of report quantity), or configure corresponding quantization parameters only for parts of AI model using phases (or parts of types of report quantities). For other AI model using phases that are not configured with quantization parameters (or other types of report quantities that are not configured with quantization parameters), the quantization parameters configured for the parts of AI model using phases (or parts of types of report quantities) may be reused, or predefined quantization parameters may be used, the embodiments of the present disclosure do not use this as a limitation. Or, for example, for other AI model using phases that are not configured with quantization parameters (or parts of types of report quantities), quantization parameters configured last time may be reused.

The following text describes how to configure the quantization parameter(s).

In some embodiments, the report quantity adopts fixed-point data, the network device may configure a quantization parameter for fixed-pointing of the report quantity, the quantization parameter including at least one of the number of quantization bits, a dynamic range of a value to be quantized, and a quantization step. The number of quantization bits refers to that how many bits are used to represent data to be quantized, the dynamic range of quantization includes maximum and minimum values of quantized data, with unit being dBm (L1-RSRP) or dB (L1-SINR), and the quantization step (unit is dB).

For example, in the scenario (6), for the AI model inference phase, the quantization parameter configured by the network device includes: a dynamic range of a value to be quantized being-140 dBm~−40 dBm, the number of quantization bits being 7 bits, and a quantization step being 1 dB.

For example, in the scenarios (1) and (4), for the AI model training phase, the quantization parameter configured by the network device includes: a dynamic range of a value to be quantized being-172 dBm~−40 dBm, the number of quantization bits being 7 bits, and a quantization step being 1 dB. Or, in order to obtain higher quantization accuracy, the number of quantization bits may be 8 bits, and the quantization step is 0.5 dB.

In some embodiments, the quantization type includes differential quantization and absolute quantization, wherein quantization parameters of report quantities to which different quantization types correspond are identical or different.

For example, for the absolute quantization, it quantizes report quantity, and the quantization parameter of the absolute quantization may include the number of quantization bits, a dynamic range, and a quantization step. For the differential quantization, it quantizes a difference value between an L1-RSRP/L1-SINR to be reported in a reporting instance and a maximum reporting value in the instance, and the quantization parameter of the differential quantization includes the number of quantization bit and a quantization step. It should be noted that in the differential quantization, the maximum reporting value is quantized by using the absolute quantization. The parameter of the absolute quantization may be the quantization parameter of the aforementioned absolute quantization configured for the absolute quantization, or a predefined quantization parameter of absolute quantization, the embodiments of the present disclosure do not use this as a limitation.

In some embodiments, when the quantization type is differential quantization, the terminal equipment may group the report quantities (for example, in the AI model training stage, if the terminal equipment needs to report measured or predicted values of all beams (beam pairs), the measured or predicted values may be grouped), and each group of report quantities corresponds to one reporting instance. In a grouped reporting instance, the maximum reporting value is quantized by using absolute quantization (using the quantization parameter of the aforementioned absolute quantization configured for the absolute quantization, or a predefined quantization parameter of absolute quantization). After calculating a difference between other L1-RSRPs/L1-SINRs to be reported and the maximum reporting value in the grouped reporting instance, the difference is quantized by means of differential quantization (by using the quantization parameter of differential quantization). Therefore, in order to support the grouped differential quantization mode, the quantization parameter may further include the number N of report quantities included in a reporting instance, said grouping is performed according to the number N and the number M of report quantities, and for each group, the differential quantization as described above is performed.

In some embodiments, the aforementioned quantization types may be explicitly indicated in the quantization parameter, that is, the quantization parameter may include a quantization type, however the embodiments of the present disclosure do not use this as a limitation. For example, a quantization type corresponding to each type of report quantity may further be predefined, or determined according to a preset rule or implicitly. For example, 1 bit may be used to indicate a quantization type. When the value of 1 bit is 0, it indicates that the quantization type is absolute quantization; when the value of 1 bit is 1, it indicates that the quantization type is differential quantization, vice versa. Or, the quantization type may be predefined or implicitly indicated for different AI model using phases and/or different types of report quantities, for example in the AI model training phase, due to the large volume of data, in order to reduce an uplink payload, differential quantization may be predefined or implicitly determined. In the AI model inference phase, in order to enhance prediction accuracy, absolute quantization may be predefined or implicitly determined, the embodiments of the present disclosure do not use this as a limitation.

The following text describes how to determine the quantization parameter is configured for which AI model using phase or type of report quantity.

In some embodiments, determining the quantization parameter is configured for which AI model using phase or type of the report quantity may be explicitly indicated, for example the network device further transmits type indication information of the report quantity and/or AI model using phase indication information to which the quantization parameter corresponds to the terminal equipment. The above indication information may be transmitted in the quantization parameter, or the quantization parameter may be transmitted in the indication information, or the quantization parameter and the indication information may be carried and transmitted respectively by the same information field/information element. Thereby, when the terminal equipment receives the above-mentioned indication information and quantization parameter, it may determine the quantization parameter is configured for which AI model using phase or type of the report quantity. For example, the AI model using phase indication information is represented by using 2 bits. When the value of 2 bits is 00, it indicates that the configured quantization parameter is configured for the AI model training phase, when the value of 2 bits is 01, it indicates that the configured quantization parameter is configured for the AI model inference phase, and when the value of 2 bits is 10, it indicates that the configured quantization parameter is configured for the AI model performance monitoring phase; the embodiments of the present disclosure do not use this as a limitation, for example the type indication information of the report quantity is represented by using 2 bits, when the value of 2 bits is 00, it indicates that the report quantity is a beam measurement result, when the value of 2 bits is 01, it indicates that the report quantity is a beam prediction result, and when the value of 2 bits is 10, it indicates that the report quantity is a performance metric value, no more examples is given here.

In some embodiments, that the quantization parameter is configured for which AI model using phase or type of report quantity may be determined according to a time occasion of transmitting the quantization parameter (for example, in which phase of the AI model, it is transmitted). For example, the network device may transmit AI model using phase triggering signaling to the terminal equipment, the quantization parameter and the triggering signaling may be transmitted separately, or the quantization parameter may be transmitted by being included in the triggering signaling, the present disclosure does not use this as a limitation. After receiving the triggering signaling, the terminal equipment triggers a corresponding AI using phase and quantizes the report quantity according to the quantization parameter, that is, the terminal equipment may determine that the received quantization parameter is used in an AI model using phase triggered by the triggering signaling.

For example, the triggering signaling may be an AI model using phase enable signal, for example the enable signal is 2-bit information. When the bit value of the enable signal is 00, it indicates enabling (triggering) a process of the AI model training phase, when the bit value of the enable signal is 01, it indicates enabling (triggering) a process of the AI model inference phase, and when the bit value of the enable signal is 10, it indicates enabling (triggering) a process of the AI model performance monitoring phase, they are just examples for description, the present disclosure does not use this as a limitation.

For example, the triggering signaling may be the type of the report quantity and/or the AI model using phase indication information. In other words, the indication information may be used as triggering signaling to trigger a corresponding AI model using phase. For example, when receiving a value being 00 of the 2-bit AI model using phase indication information, the terminal equipment triggers a process of the AI model training phase.

For example, the triggering signaling may be reference signal configuration information and/or measurement report configuration information corresponding to an AI model using phase, which implicitly triggers a process of the AI model using phase. For example, the reference signal configured by the reference signal configuration information is a measurement reference signal configured for the AI model training phase, when receiving the reference signal configuration information, the terminal equipment triggers a process of the AI model training phase, or the reference signal configured by the reference signal configuration information is a measurement reference signal configured for the AI model inference phase, when receiving the reference signal configuration information, the terminal equipment triggers a process of the AI model inference phase, no more examples is given here.

In some embodiments, the triggering signaling may be periodically transmitted or aperiodically transmitted, the embodiments of the present disclosure do not use this as a limitation.

In some embodiments, the quantization parameter and/or triggering signaling may be transmitted simultaneously, for example the quantization parameter may be transmitted by being included in the triggering signaling, or the quantization parameter and the triggering signaling may be transmitted separately, for example the quantization parameter is transmitted after the triggering signaling is transmitted, the embodiments of the present disclosure do not use this as a limitation, the quantization parameter and/or triggering signaling may be carried by RRC signaling or MAC CE signaling or DCI signaling; for example the quantization parameter may be a newly added information field or information element in RRC signaling, MAC CE signaling or DCI signaling, the triggering signaling may be a newly added information field or information element in RRC signaling, MAC CE signaling or DCI signaling, the embodiments of the present disclosure do not use this as a limitation.

In some embodiments, the network device may first receive an AI model using phase request transmitted by the terminal equipment. After receiving the request, the network device transmits the triggering signaling in response to the request. For example, for the scenario (6), when the AI model enters an inference phase, the terminal equipment may first transmit an AI model inference request to the network device, the network device transmits the triggering signaling in response to the request to trigger a process of the AI model inference phase, the above is described only by taking the scenario (6) as an example, the embodiments of the present disclosure do not use this scenario as a limitation. The AI model using phase request may be periodically transmitted or aperiodically transmitted, the embodiments of the present disclosure do not use this as a limitation.

In some embodiments, the terminal equipment obtains a report quantity by measurement, prediction or calculation. After receiving the triggering signaling and the quantization parameter, the terminal equipment quantizes the report quantity by using the quantization parameter, and transmits the quantized report quantity, the quantized report quantity is carried by a UCI or a MAC PDU. How the terminal equipment quantizes, when to report and how to report will be described in the embodiments of the aftermentioned second aspect.

In addition, in the above embodiments, the description is made by taking “the network device configures corresponding quantization parameters for a type of report quantity or an AI model using phase” as an example, however the embodiments of the present disclosure do not use this as a limitation, for example the network device may further configure corresponding quantization parameters for different AI models, for example when multiple AI models are deployed at a network device side or a terminal equipment side, corresponding quantization parameters may be configured for each AI model, for example for AI model 1, quantization parameter 1 is configured, for AI model 2, quantization parameter 2 is configured, for AI model 3, quantization parameter 3 is configured, quantization parameters 1, 2 and 3 are identical or different; or, for AI model 1, quantization parameter 1 is configured, and for AI model 2, the quantization parameter 1 is reused, etc., the embodiments of the present disclosure do not use this as a limitation, no more detail is provided here.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

Thereby, a network device configures a quantization parameter of a report quantity for a terminal equipment, thereby the terminal equipment is capable of quantizing the report quantity according to the quantization parameter, this quantization scheme is more flexible, i.e., can not only ensure the performance of an AI model but also can reduce a payload of an uplink.

### Embodiments of a Second Aspect

Embodiments of the present disclosure provide an information transceiving method, which is described from a terminal equipment side, the contents same as the embodiments of the first aspect are not repeated.

FIG. 4 is a schematic diagram of an information transceiving method in the embodiments of the present disclosure. As shown in FIG. 4, the method includes:
401, a terminal equipment receives a quantization parameter of a report quantity transmitted by a network device;
402, the terminal equipment quantizes the report quantity according to the quantization parameter; and
403, the terminal equipment transmits a quantized report quantity to the network device.

It should be noted that the above FIG. 4 only schematically describes the embodiments of the present disclosure, but the present disclosure is not limited thereto. For example, an execution step of each operation may be adjusted appropriately, moreover other some operations may be increased or reduced. Persons skilled in the art may make appropriate modifications according to the above contents, not limited to the records in the above FIG. 4.

In some embodiments, implementations of 401 may correspond to those of 301, the repeated contents are not elaborated here.

In some embodiments, the method may further include: receiving AI model using phase triggering signaling transmitted by a network device, and in 402, the terminal equipment quantizes the report quantity when receiving the quantization parameter and the triggering signaling. Implementations of the triggering signaling and of the quantization parameter are described above, and are not elaborated here.

It should be noted that, as described above, the network device may configure a corresponding quantization parameter for each AI model using phase, for example the quantization parameter may be transmitted together with the triggering signaling or they are transmitted separately, the terminal equipment quantizes the report quantity according to triggering signaling 1 (corresponding to the AI model using phase A) and quantization parameter 1 (corresponding to the AI model using phase A), and the terminal equipment quantizes the report quantity according to triggering signaling 2 (corresponding to the AI model using phase B) and quantization parameter 2 (corresponding to the AI model using phase B). However the embodiments of the present application do not use this as a limitation, the network device may configure quantization parameter for parts of AI model using phases, for example only configures quantization parameter 1 for the AI model using phase A, and the terminal equipment quantizes the report quantity according to the configured quantization parameter 1 when receiving the triggering signaling 1 of the AI model using phase A. Since the network device does not configure a corresponding quantization parameter for the AI model using phase B, the terminal equipment may reuse the received quantization parameter 1 or the latest received quantization parameter to quantize the report quantity when receiving the triggering signaling 2 of the AI model using phase B, no more examples is given here.

In some embodiments, the method may further include: the terminal equipment transmits an AI model using phase request to the network device and receives triggering signaling transmitted by the network device in response to the request, for example for the scenario (6), when the AI model enters an inference phase, the terminal equipment may first transmit an AI model inference request to the network device, and then receive the triggering signaling to trigger a process of the AI model inference phase. Implementations of the AI model using phase request are described above, and are not elaborated here.

The following is specifically illustrated in combination with the examples from scenarios (1) to (7) in the embodiments of the first aspect.

For example, for scenarios (1) and (4), the network device transmits triggering signaling to the terminal equipment to trigger a process of the AI model training phase, and transmits a quantization parameter configured for the AI model training phase (or for a measured value) to the terminal equipment (as described above, the quantization parameter and the triggering signaling may be transmitted simultaneously or separately). After receiving the triggering signaling, the terminal equipment triggers the process of the AI model training phase, and after obtaining all the beam measurement results, the terminal equipment quantizes all the beam measurement results obtained by measurement according to the quantization parameter, and reports quantization results as measurement reporting results to the network device via a UCI or a MAC PDU.

For example, for scenario (2), the network device transmits triggering signaling to the terminal equipment to trigger a process of the AI model inference phase, and transmits a quantization parameter configured for the AI model inference phase (or for a measured value) to the terminal equipment (as described above, the quantization parameter and the triggering signaling may be transmitted simultaneously or separately). After receiving the triggering signaling, the terminal equipment triggers the process of the AI model inference phase, and after obtaining measurement results of parts of beams by measurement, the terminal equipment quantizes parts of beam measurement results according to the quantization parameter, and reports quantization results as measurement reporting results to the network device via a UCI or a MAC PDU.

For example, for scenario (3), the network device transmits triggering signaling to the terminal equipment to trigger a process of the AI model performance monitoring phase, and transmits a quantization parameter configured for the AI model performance monitoring phase (or for a measured value) to the terminal equipment (as described above, the quantization parameter and the triggering signaling may be transmitted simultaneously or separately). After receiving the triggering signaling, the terminal equipment triggers the process of the AI model performance monitoring phase, and after obtaining measurement results corresponding to parts of beams (beam pairs) or all beams (beam pairs) by measurement, the terminal equipment quantizes measurement results according to the quantization parameter, and reports quantization results as measurement reporting results to the network device via a UCI or a MAC PDU.

For example, for scenario (5), the network device transmits triggering signaling to the terminal equipment to trigger a process of the AI model performance monitoring phase, and transmits a quantization parameter configured for the AI model performance monitoring phase (or for a measured value and a predicted value) to the terminal equipment (as described above, the quantization parameter and the triggering signaling may be transmitted simultaneously or separately). After receiving the triggering signaling, the terminal equipment triggers the process of the AI model performance monitoring phase, obtains measurement results corresponding to parts of beams (beam pairs) or all beams (beam pairs) by measurement, and uses an AI model to obtain a prediction result, quantizes measurement results obtained by measurement and prediction results according to the quantization parameter, and reports quantization results as measurement reporting results to the network device via a UCI or a MAC PDU.

For example, for scenario (7), the network device transmits triggering signaling to the terminal equipment to trigger a process of the AI model performance monitoring phase, and transmits a quantization parameter configured for the AI model performance monitoring phase (or for a performance metric value) to the terminal equipment (as described above, the quantization parameter and the triggering signaling may be transmitted simultaneously or separately). After receiving the triggering signaling, the terminal equipment triggers the process of the AI model performance monitoring phase, obtains measurement results of parts of beams by measurement, uses an AI model to obtain a prediction result, calculates a performance metric value according to measurement results and the prediction result, quantizes the performance metric value obtained by calculation, and reports quantization results as measurement reporting results to the network device via a UCI or a MAC PDU.

For example, for scenario (6), the terminal equipment may first transmits an AI model using (model inference) phase request to the network device, the network device transmits triggering signaling to the terminal equipment in response to the request to trigger a process of the AI model inference phase, and transmits a quantization parameter configured for the AI model inference phase (or for a predicted value) to the terminal equipment (as described above, the quantization parameter and the triggering signaling may be transmitted simultaneously or separately). After receiving the triggering signaling, the terminal equipment triggers the process of the AI model inference phase, and after obtaining measurement results of parts of beams by measurement, uses an AI model to obtain a prediction result, quantizes the beam prediction results according to the quantization parameter, and reports quantization results as measurement reporting results to the network device via a UCI or a MAC PDU.

In the above examples, the description is made by taking “the network device configures a corresponding quantization parameter for each AI model using phase, the quantization parameter may be transmitted together with corresponding triggering signaling that triggers the AI model using phase or they are transmitted separately” as an example, however the embodiments of the present disclosure do not use this as a limitation, the network device may configure quantization parameters for parts of the AI model using phase, the terminal equipment may reuse other configured quantization parameters or the latest received quantization parameters to quantize report quantity corresponding to AI model using phases that are not configured with quantization parameters, no more examples are given here.

Thereby, a network device configures a quantization parameter of a report quantity for a terminal equipment, thereby the terminal equipment is capable of quantizing the report quantity according to the quantization parameter, this quantization scheme is more flexible, i.e., can not only ensure the performance of an AI model but also can reduce a payload of an uplink.

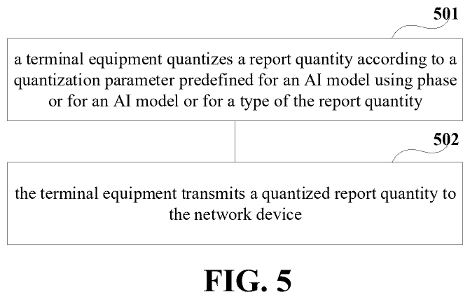

In the above examples, the network device configures corresponding quantization parameters for each AI model using phase or parts of AI model using phases, however the embodiments of the present disclosure do not use this as a limitation, the network device may not configure corresponding quantization parameters for any AI model using phase, the terminal equipment performs quantization by using a predefined quantization parameter for an AI model using phase or for a type of a report quantity, which is described below in combination with the embodiment of FIG. 5.

FIG. 5 is a schematic diagram of an information transceiving method in the embodiments of the present disclosure. As shown in FIG. 5, the method includes:
501, a terminal equipment quantizes a report quantity according to a quantization parameter predefined for an AI model using phase or for the AI model or for a type of the report quantity, wherein quantization parameters of report quantities to which different types of report quantities and/or different AI model using phases and/or different types of AI models correspond are identical or different; and
502, the terminal equipment transmits a quantized report quantity to the network device.

In some embodiments, a difference from the aforementioned implementations lies in that quantization parameters of report quantities to which types of report quantity and/or AI model using phases and/or AI models correspond are predefined and are not configured by a network device. For specific content of the predefined quantization parameter is similar to that of the configured quantization parameter, the aforementioned embodiments may be referred to, for example the predefined quantization parameter includes at least one of the number of quantization bits, a dynamic range of a value to be quantized, or a quantization step. The number of quantization bits refers to that how many bits are used to represent data to be quantized, the dynamic range of quantization includes maximum and minimum values of quantized data, with unit being dBm (L1-RSRP) or dB (L1-SINR), and the quantization step (unit is dB).

In some embodiments, the quantization type includes differential quantization and absolute quantization, wherein predefined quantization parameters of report quantities to which different quantization types correspond are identical or different.

For example, for the absolute quantization, it quantizes report quantity, and the predefined quantization parameter of the absolute quantization may include the number of quantization bits, a dynamic range, and a quantization step. For the differential quantization, it quantizes a difference value between an L1-RSRP/L1-SINR to be reported in a reporting instance and a maximum reporting value in the instance, and the predefined quantization parameter of the differential quantization includes the number of quantization bits and a quantization step. It should be noted that in differential quantization, the maximum reporting value is quantized by using absolute quantization, and the parameter of the absolute quantization is predefined.

In some embodiments, when the quantization type is differential quantization, the predefined quantization parameter may further include the number N of report quantities included in a reporting instance, said grouping is performed according to the number N and the number M of report quantities, and for each group, the differential quantization as described above is performed.

When to use absolute quantization and when to use differential quantization may further be predefined or default, the embodiments of the present disclosure do not use this as a limitation, for example the absolute quantization is predefined-adopted for the AI model inference phase, and differential quantization is predefined-adopted for the AI model training phase, etc., no more examples are given here.

That is to say, a group of quantization parameters may be predefined for the AI model inference phase, a group of quantization parameters may be predefined for the AI model training phase, and a group of quantization parameters may be predefined for the AI model performance monitoring phase. Quantization parameters in the above groups are identical or different.

In some embodiments, the method may further include: receiving AI model using phase triggering signaling transmitted by a network device, and in 501, the terminal equipment quantizes the report quantities according to the predefined quantization parameter corresponding to an AI model using phase triggered by the triggering signaling when receiving the triggering signaling. Implementations of the triggering signaling and of the quantization parameter are described above, and are not elaborated here.

In some embodiments, the method may further include: the terminal equipment transmits an AI model using phase request to the network device and receives triggering signaling transmitted by the network device in response to the request, for example for the scenario (6), when the AI model enters an inference phase, the terminal equipment may first transmit an AI model inference request to the network device, and then receive the triggering signaling to trigger a process of the AI model inference phase, the above is described only by taking the scenario (6) as an example, the embodiments of the present disclosure do not use this scenario as a limitation. Implementations of the AI model using phase request are described above, and are not elaborated here.

The following is specifically illustrated in combination with the examples from scenarios (1) to (7) in the embodiments of the first aspect.

For example, for scenarios (1) and (4), the network device transmits triggering signaling to the terminal equipment to trigger a process of the AI model training phase. After receiving the triggering signaling, the terminal equipment triggers the process of the AI model training phase, and after obtaining all the beam measurement results, quantizes all the beam measurement results obtained by measurement according to the predefined quantization parameter for the AI model training phase (or for a measured value), and reports quantization results as measurement reporting results to the network device via a UCI or a MAC PDU.

For example, for scenario (2), the network device transmits triggering signaling to the terminal equipment to trigger a process of the AI model inference phase. After receiving the triggering signaling, the terminal equipment triggers the process of the AI model inference phase, and after obtaining measurement results of parts of beams by measurement, quantizes parts of beam measurement results according to the predefined quantization parameter for the AI model inference phase (or for a measured value), and reports quantization results as measurement reporting results to the network device via a UCI or a MAC PDU.

For example, for scenario (3), the network device transmits triggering signaling to the terminal equipment to trigger a process of the AI model performance monitoring phase. After receiving the triggering signaling, the terminal equipment triggers the process of the AI model performance monitoring phase, and after obtaining measurement results of parts of beams (beam pairs) or all beams (beam pairs) by measurement, quantizes measurement results according to the predefined quantization parameter for the AI model performance monitoring phase (or for a measured value), and reports quantization results as measurement reporting results to the network device via a UCI or a MAC PDU.

For example, for scenario (5), the network device transmits triggering signaling to the terminal equipment to trigger a process of the AI model performance monitoring phase. After receiving the triggering signaling, the terminal equipment triggers the process of the AI model performance monitoring phase, obtains measurement results of parts of beams (beam pairs) or all beams (beam pairs) by measurement, and uses an AI model to obtain a prediction result, quantizes measurement results and prediction results obtained by measurement according to the predefined quantization parameter for the AI model performance monitoring phase (or for a measured value and a predicted value), and reports quantization results as measurement reporting results to the network device via a UCI or a MAC PDU.

For example, for scenario (7), the network device transmits triggering signaling to the terminal equipment to trigger a process of the AI model performance monitoring phase. After receiving the triggering signaling, the terminal equipment triggers the process of the AI model performance monitoring phase, obtains measurement results of parts of beams by measurement, uses an AI model to obtain a prediction result, calculates a performance metric value according to measurement results and the prediction result, quantizes the performance metric value obtained by calculation according to the predefined quantization parameter for the AI model performance monitoring phase (or for the performance metric value), and reports quantization results as measurement reporting results to the network device via a UCI or a MAC PDU.

For example, for scenario (6), the terminal equipment may first transmit an AI model using phase (model inference) request to the network device, the network device transmits triggering signaling to the terminal equipment in response to the request to trigger a process of the AI model inference phase. After receiving the triggering signaling, the terminal equipment triggers the process of the AI model inference phase, and after obtaining measurement results of parts of beams by measurement, uses an AI model to obtain a prediction result, quantizes the beam prediction results according to the quantization parameter for the AI model inference phase (or for a predicted value), and reports quantization results as measurement reporting results to the network device via a UCI or a MAC PDU.

In addition, in the above embodiments, the description is made by taking “predefining corresponding quantization parameters for a type of the report quantity or an AI model using phase” as an example, however the embodiments of the present disclosure do not use this as a limitation, for example corresponding quantization parameters for different AI models may further be predefined, for example when multiple AI models are deployed at a network device side or a terminal equipment side, corresponding quantization parameters may be predefined for each AI model, for example for AI model 1, quantization parameter 1 is predefined, for AI model 2, quantization parameter 2 is predefined, for AI model 3, quantization parameter 3 is predefined, quantization parameters 1, 2 and 3 are identical or different; the embodiments of the present disclosure do not use this as a limitation, no more detail is provided here.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

Thereby, a terminal equipment is capable of quantizing a report quantity according to a predefined quantization parameter, quantization parameters of report quantities to which different types of report quantities and/or different AI model using phases and/or different AI models correspond are identical or different, this quantization mode is more flexible, i.e., can not only ensure the performance of an AI model but also can reduce a payload of an uplink.

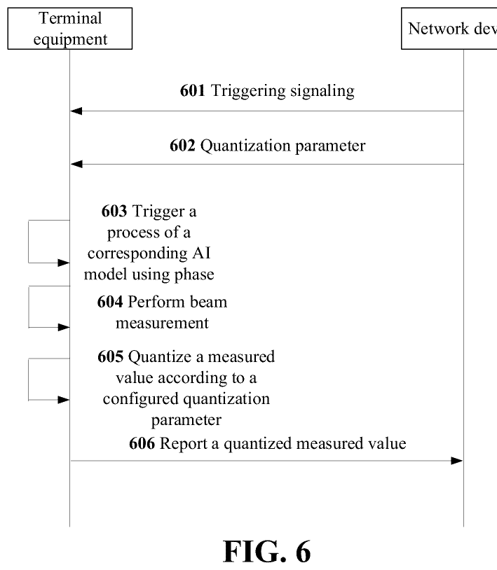

FIG. 6 is a schematic diagram (scenarios 1 to 5) of an information transceiving method in the embodiments of the present disclosure. As shown in FIG. 6, an AI model is deployed at a network device side or at a terminal equipment side, but the AI model is trained by the network device and the AI model performance is monitored by the network device. The method includes:
601, a network device transmits the triggering signaling to a terminal equipment;
602, the network device transmits a quantization parameter to the terminal equipment;
603, the terminal equipment triggers a process of a corresponding AI model using phase according to the triggering signaling;
604, the terminal equipment performs beam measurement;
605, the terminal equipment quantizes a measured value according to a configured quantization parameter corresponding to the AI model using phase in 603; and
606, the terminal equipment reports a quantized measured value.

In this embodiment, the quantization parameter in 602 may be transmitted by being included in the triggering signaling, or the quantization parameter in 602 and the triggering signaling are transmitted separately. When the AI model is deployed at the terminal equipment side, but the AI model performance is monitored by the network device, in 604, a beam measurement value further needs to be input into the AI model to obtain a predicted value, and in 605, the predicted value further needs to be quantized according to the configured quantization parameter, and in 606, the quantized predicted value is also reported to the network device.

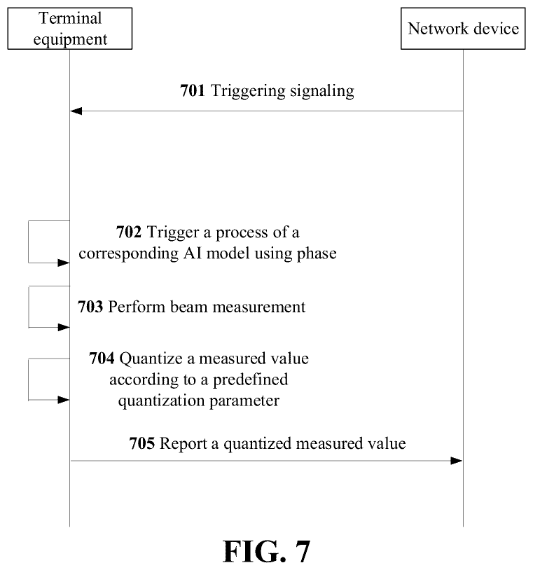

FIG. 7 is a schematic diagram (scenarios 1 to 5) of an information transceiving method in the embodiments of the present disclosure. As shown in FIG. 7, an AI model is deployed at a network device side or at a terminal equipment side, but the AI model is trained by the network device and the AI model performance is monitored by the network device. The method includes:
701, a network device transmits the triggering signaling to a terminal equipment;
702, the terminal equipment triggers a process of a corresponding AI model using phase according to the triggering signaling;
703, the terminal equipment performs beam measurement;
704, the terminal equipment quantizes a measured value according to a predefined quantization parameter corresponding to the AI model using phase in 702; and
705, the terminal equipment reports a quantized measured value.

When the AI model is deployed at the terminal equipment side, but the AI model performance is monitored by the network device, in 703, a beam measurement value further needs to be input into the AI model to obtain a predicted value, and in 704, the predicted value further needs to be quantized according to the predefined quantization parameter, and in 705, the quantized predicted value is also reported to the network device.

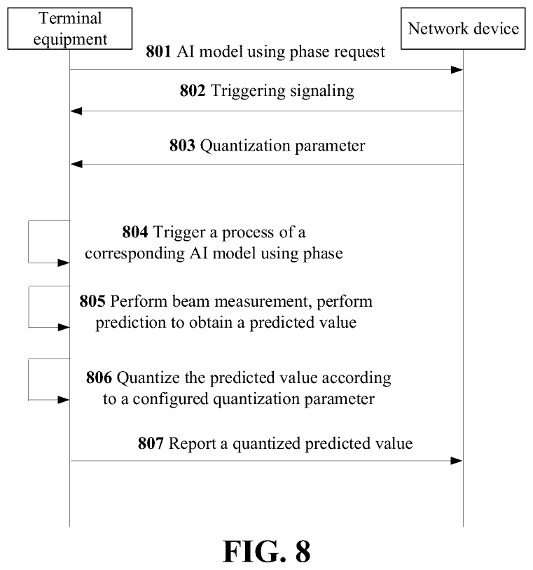

FIG. 8 is a schematic diagram of an information transceiving method in the embodiments of the present disclosure. As shown in FIG. 8, the AI model is deployed at the terminal equipment side, the method includes:
801, a terminal equipment transmits an AI model using phase request to a network device.
802, the network device transmits the triggering signaling to the terminal equipment;
803, the network device transmits a quantization parameter to the terminal equipment;
804, the terminal equipment triggers a process of a corresponding AI model using phase according to the triggering signaling;
805, the terminal equipment performs beam measurement, inputs a beam measurement value into the AI model to obtain a predicted value;
806, the terminal equipment quantizes the predicted value according to a configured quantization parameter corresponding to the AI model using phase in 803; and
807, the terminal equipment reports a quantized predicted value.

In this embodiment, the quantization parameter in 803 may be transmitted by being included in the triggering signaling, or the quantization parameter in 803 and the triggering signaling are transmitted separately.

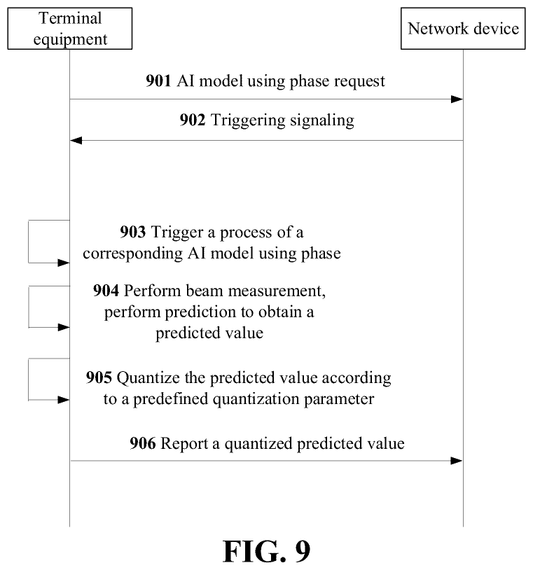

FIG. 9 is a schematic diagram of an information transceiving method in the embodiments of the present disclosure. As shown in FIG. 9, the AI model is deployed at the terminal equipment side, the method includes:
901, a terminal equipment transmits an AI model using phase request to a network device.
902, the network device transmits the triggering signaling to the terminal equipment;
903, the terminal equipment triggers a process of a corresponding AI model using phase according to the triggering signaling;
904, the terminal equipment performs beam measurement, inputs a beam measurement value into the AI model to obtain a predicted value;
905, the terminal equipment quantizes the predicted value according to a predefined quantization parameter corresponding to the AI model using phase in 803; and
906, the terminal equipment reports a quantized predicted value.

Description is made by taking quantization of the predicted value in the above FIG. 8 and FIG. 9, but the embodiments of the present disclosure do not use this as a limitation, the quantized report quantity and the quantity to be reported may further include a measured value or a performance metric value, no more examples are given here.

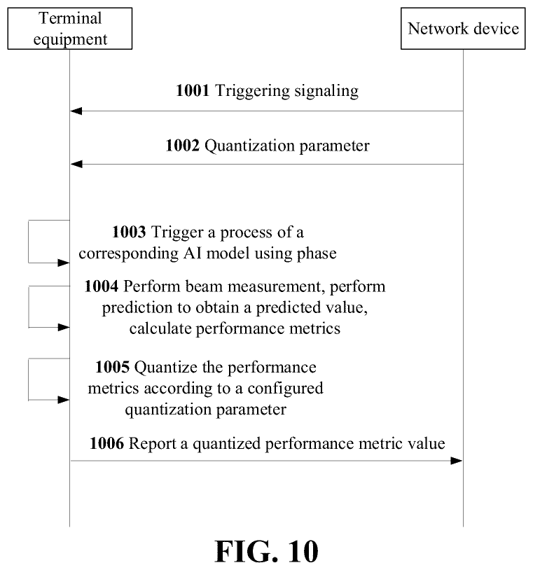

FIG. 10 is a schematic diagram (scenario 7) of an information transceiving method in the embodiments of the present disclosure. As shown in FIG. 10, the AI model is deployed at a terminal equipment side, the AI model performance is monitored by the terminal equipment. The method includes:
1001, a network device transmits the triggering signaling to a terminal equipment;
1002, the network device transmits a quantization parameter to the terminal equipment;
1003, the terminal equipment triggers a process of a corresponding AI model using phase according to the triggering signaling;
1004, the terminal equipment performs beam measurement, inputs a beam measurement value into the AI model to obtain a predicted value, and calculates performance metrics according to the measured value and the predicted value;
1005, the terminal equipment quantizes the performance metrics according to a configured quantization parameter corresponding to the AI model using phase in 1002; and
1006, the terminal equipment reports a quantized performance metric value.

In this embodiment, the quantization parameter in 1002 may be transmitted by being included in the triggering signaling, or the quantization parameter in 1002 and the triggering signaling are transmitted separately.

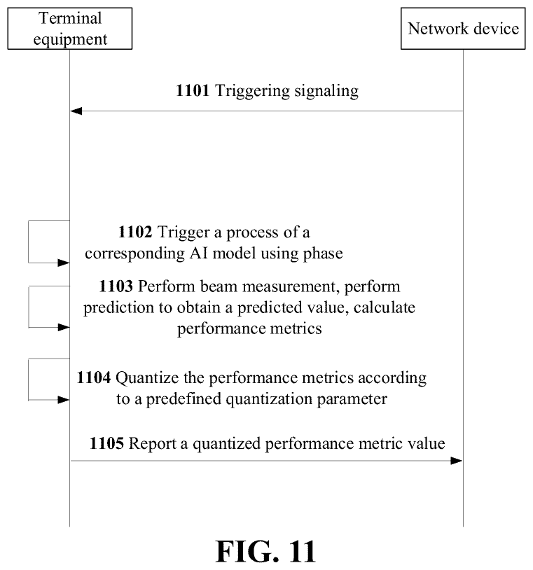

FIG. 11 is a schematic diagram (scenario 7) of an information transceiving method in the embodiments of the present disclosure. As shown in FIG. 11, the AI model is deployed at a terminal equipment side, the AI model performance is monitored by the terminal equipment. The method includes:
1101, a network device transmits the triggering signaling to a terminal equipment;
1102, the terminal equipment triggers a process of a corresponding AI model using phase according to the triggering signaling;
1103, the terminal equipment performs beam measurement, inputs a beam measurement value into the AI model to obtain a predicted value, and calculates performance metrics according to the measured value and the predicted value;
1104, the terminal equipment quantizes the performance metrics according to a predefined quantization parameter corresponding to the AI model using phase in 1002; and
1105, the terminal equipment reports a quantized performance metric value.

For “the above-mentioned beam to be measured may be configured by reference signal configuration information”, related arts may be specifically referred to, which are not elaborated here.

### Embodiments of a Third Aspect

Embodiments of the present disclosure provide an information transceiving apparatus. The apparatus for example may be a terminal equipment, or may be one or more parts or components configured in the terminal equipment. The contents same as the embodiments of the second aspect are not repeated.

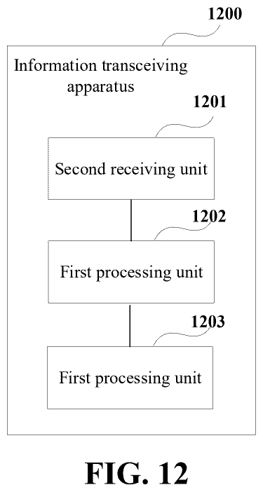

FIG. 12 is a schematic diagram of an information transceiving apparatus in the embodiments of the present disclosure. As shown in FIG. 12, the information transceiving apparatus 1200 includes:
a second receiving unit 1201 configured to receive a quantization parameter of report quantity transmitted by a network device;
a first processing unit 1202 configured to quantize report quantity according to the quantization parameter; and
a second transmitting unit 1203 configured to transmit a quantized report quantity to the network device.

In some embodiments, implementations of the second receiving unit 1201, the first processing unit 1202 and the second transmitting unit 1203 correspond to 401-403, which are not elaborated here.

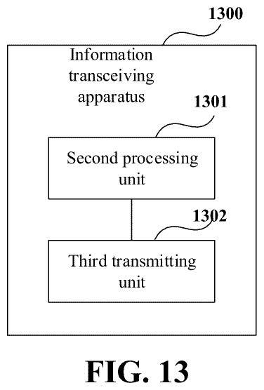

FIG. 13 is a schematic diagram of an information transceiving apparatus in the embodiments of the present disclosure. As shown in FIG. 13, the information transceiving apparatus 1300 includes:
a second processing unit 1301 configured to quantize a report quantity according to a quantization parameter predefined for an AI model using phase or for an AI model or for a type of the report quantity, wherein quantization parameters of report quantities to which different types of report quantities and/or different AI model using phases and/or different AI models correspond are identical or different; and
a third transmitting unit 1302 configured to transmit a quantized report quantity to the network device.

In some embodiments, implementations of the second processing unit 1301 and the third transmitting unit 1302 correspond to 501-502, which are not elaborated here.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

It's worth noting that the above only describes components or modules related to the present disclosure, but the present disclosure is not limited to this. The information transceiving apparatuses 1200 and 1300 may further include other components or modules. For detailed contents of these components or modules, relevant technologies may be referred to.

Moreover, for the sake of simplicity, FIG. 12 and FIG. 13 only exemplarily show a connection relationship or signal direction between components or modules, however persons skilled in the art should know that various relevant technologies such as bus connection can be used. The above components or modules may be realized by a hardware facility such as a processor, a memory, a transmitter, a receiver, etc. The embodiments of the present disclosure have no limitation to this.

### Embodiments of a Fourth Aspect

Embodiments of the present disclosure provide an information transceiving apparatus. The apparatus may be a network device, or may be one or more parts or components configured in the network device. The contents same as the embodiments of the first aspect are not repeated.

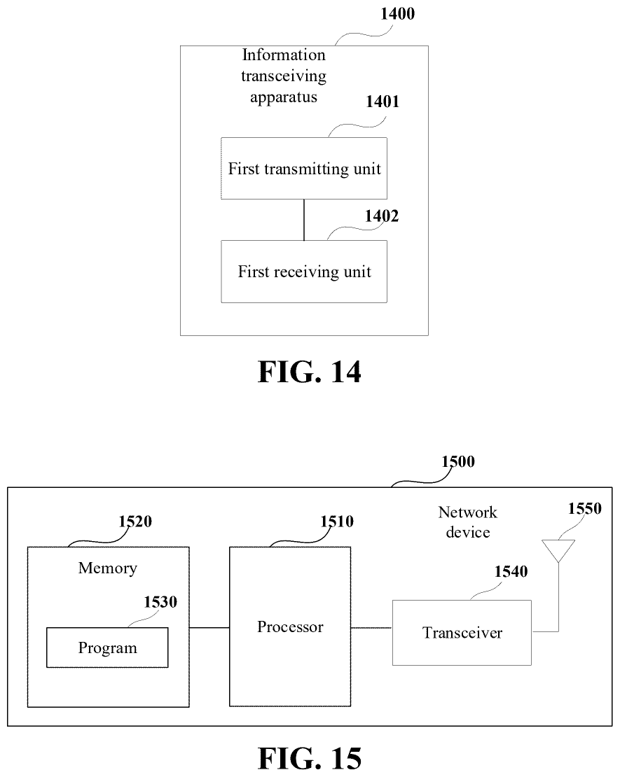

FIG. 14 is a schematic diagram of an information transceiving apparatus in the embodiments of the present disclosure. As shown in FIG. 14, the information transceiving apparatus 1400 includes:
a first transmitting unit 1401 configured to transmit to a terminal equipment a quantization parameter of a report quantity; and
a first receiving unit 1402 configured to receive a report quantity quantized by the terminal equipment according to the quantization parameter.

In some embodiments, implementations of the first transmitting unit 1401 and the first receiving unit 1402 correspond to 301-302, which are not elaborated here.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

It's worth noting that the above only describes components or modules related to the present disclosure, but the present disclosure is not limited to this. The information transceiving apparatus 1400 may further include other components or modules. For detailed contents of these components or modules, relevant technologies may be referred to.

Moreover, for the sake of simplicity, FIG. 14 only exemplarily shows a connection relationship or signal direction between components or modules, however persons skilled in the art should know that various relevant technologies such as bus connection may be used. The above components or modules may be realized by a hardware facility such as a processor, a memory, a transmitter, a receiver, etc. The embodiments of the present disclosure have no limitation to this.

### Embodiments of a Fifth Aspect

Embodiments of the present disclosure further provide a communication system, FIG. 1 may be referred to, the contents same as the embodiments of the first to fourth aspects are not repeated.

In some embodiments, a communication system 100 at least may include: a network device 101 and/or a terminal equipment 102, the network device transmits to the terminal equipment a quantization parameter of a report quantity; and the network device receives a report quantity quantized by the terminal equipment according to the quantization parameter.

In some embodiments, a communication system 100 at least may include: a network device 101 and/or a terminal equipment 102, the terminal equipment quantizes a report quantity according to a quantization parameter predefined for an AI model using phase or for an AI model or for a type of the report quantity, wherein quantization parameters of report quantities to which different types of report quantities and/or different AI model using phases and/or different AI models correspond are identical or different; and transmits a quantized report quantity to the network device. The network device receives the quantized report quantity transmitted by the terminal equipment.

In some embodiments, for implementations of the quantization parameters and the report quantity, the embodiments of the first and second aspects may be referred to, detailed description is omitted here.

Embodiments of the present disclosure further provide a network device, for example may be a base station, but the present disclosure is not limited to this, it may also be other network device.

FIG. 15 is a composition schematic diagram of a network device in the embodiments of the present disclosure. As shown in FIG. 15, the network device 1500 may include: a processor 1510 (such as a central processing unit (CPU)) and a memory 1520; the memory 1520 is coupled to the processor 1510. The memory 1520 may store various data; moreover, also stores a program 1530 for information processing, and executes the program 1530 under the control of the processor 1510.

For example, the processor 1510 may be configured to execute a program to implement an information transceiving method as described in the embodiments of the first aspect.

In addition, as shown in FIG. 15, the network device 1500 may further include: a transceiver 1540 and an antenna 1550, etc.; wherein the functions of said components are similar to relevant arts, which are not repeated here. It's worth noting that the network device 1500 does not have to include all the components shown in FIG. 15. Moreover, the network device 1500 may further include components not shown in FIG. 15, related arts may be referred to.

Embodiments of the present disclosure further provide a terminal equipment, but the present disclosure is not limited to this, it may also be other device.

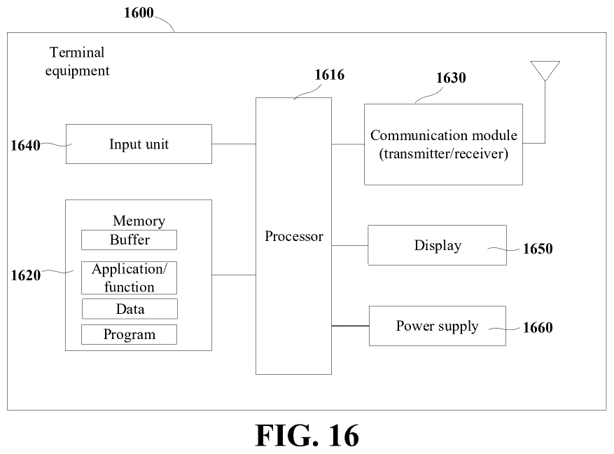

FIG. 16 is a schematic diagram of a terminal equipment in the embodiments of the present disclosure. As shown in FIG. 16, the terminal equipment 1600 may include a processor 1616 and a memory 1620; the memory 1620 stores data and programs, and is coupled to the processor 1616. It's worth noting that this figure is exemplary; other types of structures can also be used to supplement or replace this structure, so as to realize a telecommunication function or other functions.

For example, the processor 1616 may be configured to execute a program to implement the information transceiving method as described in the embodiments of the second aspect.

As shown in FIG. 16, the terminal equipment 1600 may further include: a communication module 1630, an input unit 1640, a display 1650 and a power supply 1660. The functions of said components are similar to related arts, which are not repeated here. It's worth noting that the terminal equipment 1600 does not have to include all the components shown in FIG. 16, said components are not indispensable. Moreover, the terminal equipment 1600 may further include components not shown in FIG. 16, related arts may be referred to.

Embodiments of the present disclosure further provide a computer program, wherein when a terminal equipment executes the program, the program enables the terminal equipment to execute an information transceiving method described in the embodiments of the second aspect.

Embodiments of the present disclosure further provide a storage medium in which a computer program is stored, wherein the computer program enables a terminal equipment to execute an information transceiving method described in the embodiments of the second aspect.

Embodiments of the present disclosure further provide a computer program, wherein when a network device executes the program, the program enables the network device to execute an information transceiving method described in the embodiments of the first aspect.

Embodiments of the present disclosure further provide a storage medium in which a computer program is stored, wherein the computer program enables a network device to execute an information transceiving method described in the embodiments of the first aspect.

The apparatus and method in the present disclosure may be realized by hardware, or may be realized by combining hardware with software. The present disclosure relates to such a computer readable program, when the program is executed by a logic component, the computer readable program enables the logic component to realize the device described in the above text or a constituent component, or enables the logic component to realize various methods or steps described in the above text. The present disclosure further relates to a storage medium storing the program, such as a hard disk, a magnetic disk, an optical disk, a DVD, a flash memory and the like.

By combining with the method/device described in the embodiments of the present disclosure, it may be directly reflected as hardware, a software executed by a processor, or a combination of the two. For example, one or more in the functional block diagram or one or more combinations in the functional block diagram as shown in the drawings may correspond to software modules of a computer program flow, and may also correspond to hardware modules. These software modules may respectively correspond to the steps as shown in the drawings. These hardware modules may be realized by solidifying these software modules e.g. using a field-programmable gate array (FPGA).

A software module may be located in a RAM memory, a flash memory, a ROM memory, an EPROM memory, an EEPROM memory, a register, a hard disk, a mobile magnetic disk, a CD-ROM or a storage medium in any other form as known in this field. A storage medium may be coupled to a processor, thereby enabling the processor to read information from the storage medium, and to write the information into the storage medium; or the storage medium may be a constituent part of the processor. The processor and the storage medium may be located in an ASIC. The software module may be stored in a memory of a mobile terminal, and may also be stored in a memory card of the mobile terminal. For example, if a device (such as the mobile terminal) adopts a MEGA-SIM card with a larger capacity or a flash memory apparatus with a large capacity, the software module may be stored in the MEGA-SIM card or the flash memory apparatus with a large capacity.

One or more in the functional block diagram or one or more combinations in the functional block diagram as described in the drawings may be implemented as a general-purpose processor for performing the functions described in the present disclosure, a digital signal processor (DSP), an application-specific integrated circuit (ASIC), a field-programmable gate array (FPGA) or other programmable logic device, discrete gate or transistor logic device, discrete hardware components or any combination thereof. One or more in the functional block diagram or one or more combinations in the functional block diagram as described in the drawings may further be implemented as a combination of computer equipments, such as a combination of a DSP and a microprocessor, a plurality of microprocessors, one or more microprocessors combined and communicating with the DSP or any other such configuration.

The present disclosure is described by combining with the specific implementations, however persons skilled in the art should clearly know that these descriptions are exemplary and do not limit the protection scope of the present disclosure. Persons skilled in the art may make various variations and modifications to the present disclosure according to the spirit and principle of the present disclosure, these variations and modifications are also within the scope of the present disclosure.

As for the implementations including the above embodiments, the following supplements are further disclosed:

1. An information transceiving method, applicable to a network device, characterized in that the method includes:
transmitting to a terminal equipment a quantization parameter of a report quantity by the network device; and
receiving, by the network device, a report quantity quantized by the terminal equipment according to the quantization parameter.

2. The method according to supplement 1, wherein quantization parameters of different types of report quantities are identical or different.

3. The method according to supplement 1 or 2, wherein quantization parameters of report quantities to which different AI model using phases and/or different AI models correspond are identical or different.

4. The method according to supplement 2, wherein the types of report quantities include a beam measurement result, a beam prediction result, and an AI model performance metric result.

5. The method according to supplement 3, wherein the AI model using phases include: an AI model inference phase, an AI model training phase, and an AI model performance monitoring phase.

6. The method according to any one of supplements 1 to 5, wherein the quantization parameter includes at least one of the number of quantization bits, a dynamic range of a value to be quantized, and a quantization step.

7. The method according to supplement 6, wherein the quantization parameter further includes a quantization type, the quantization type including differential quantization and absolute quantization.

8. The method according to supplement 7, wherein quantization parameters of report quantities to which different quantization types correspond are identical or different.

9. The method according to supplement 7, wherein when the quantization type is differential quantization, the quantization parameter further includes the number of report quantities included in a reporting instance.

10. The method according to any one of supplements 1 to 9, wherein the method further includes:
transmitting, by the network device, type of the report quantity and/or AI model using phase indication information to which the quantization parameter corresponds to the terminal equipment.

11. The method according to any one of supplements 1 to 10, wherein the method further includes:
transmitting, by the network device, AI model using phase triggering signaling to the terminal equipment.

12. The method according to supplement 11, wherein the triggering signaling includes the type of the report quantity and/or the AI model using phase indication information corresponding to the quantization parameter, or reference signal configuration information and/or measurement report configuration information corresponding to the AI model using phase.

13. The method according to supplement 11, wherein the method further includes:
receiving, by the network device, an AI model using phase request transmitted by the terminal equipment, and transmitting, by the network device, the AI model using phase triggering signaling to the terminal equipment in response to the request.

14. The method according to supplement 11 or 13, wherein the quantization parameter is carried in the triggering signaling.

15. The method according to any one of supplements 11 to 14, wherein the triggering signaling is periodically transmitted or aperiodically transmitted.

16. The method according to any one of supplements 11 to 15, wherein the quantization parameter and/or the triggering signaling is/are carried by RRC signaling or MAC CE signaling or DCI signaling, and the quantized report quantity is carried by UCI or an MAC PDU.

17. An information transceiving method, applicable to a terminal equipment, characterized in that the method includes:
receiving, by the terminal equipment, a quantization parameter of a report quantity transmitted by a network device;
quantizing, by the terminal equipment, the report quantity according to the quantization parameter; and
transmitting, by the terminal equipment, the quantized report quantity to the network device.

18. The method according to supplement 17, wherein quantization parameters of different types of report quantities are identical or different.

19. The method according to supplement 17 or 18, wherein quantization parameters of report quantities to which different AI model using phases and/or different AI models correspond are identical or different.

20. The method according to supplement 17, wherein the types of report quantities include a beam measurement result, a beam prediction result, and an AI model performance metric result.

21. The method according to supplement 19, wherein the AI model using phases include: an AI model inference phase, an AI model training phase, and an AI model performance monitoring phase.

22. The method according to any one of supplements 17 to 21, wherein the quantization parameter includes at least one of the number of quantization bits, a dynamic range of a value to be quantized, and a quantization step.

23. The method according to supplement 22, wherein the quantization parameter further includes a quantization type, the quantization type including differential quantization and absolute quantization.

24. The method according to supplement 23, wherein quantization parameters of report quantities to which different quantization types correspond are identical or different.

25. The method according to supplement 24, wherein when the quantization type is differential quantization, the quantization parameter further includes the number of report quantities included in a reporting instance.

26. The method according to any one of supplements 17 to 25, wherein the method further includes:
receiving, by the terminal equipment, type of the report quantity and/or AI model using phase indication information to which the quantization parameter corresponds, transmitted by the network device.

27. The method according to any one of supplements 17 to 26, wherein the method further includes:
receiving, by the terminal equipment, AI model using phase triggering signaling transmitted by a network device, and quantizing report quantity when receiving the quantization parameter and the triggering signaling.

28. The method according to supplement 27, wherein the triggering signaling includes the type of the report quantity and/or the AI model using phase indication information corresponding to the quantization parameter, or reference signal configuration information and/or measurement report configuration information corresponding to the AI model using phase.

29. The method according to supplement 27 or 28, wherein, the method further includes:
transmitting, by the terminal equipment, an AI model using phase request to the network device, and receiving the AI model using phase triggering signaling transmitted by the network device in response to the request.

30. The method according to any one of supplements 27 or 29, wherein the quantization parameter is carried in the triggering signaling.

31. The method according to any one of supplements 27 to 29, wherein the triggering signaling is periodically transmitted or aperiodically transmitted.

32. The method according to any one of supplements 17 to 31, wherein the quantization parameter and/or the triggering signaling is/are carried by RRC signaling or MAC CE signaling or DCI signaling, and the quantized report quantity is carried by UCI or an MAC PDU.

33. An information transceiving method, applicable to a terminal equipment, characterized in that the method includes:
quantizing, by the terminal equipment, a report quantity according to a quantization parameter predefined for an AI model using phase or for an AI model or for a type of report quantity, wherein quantization parameters of report quantities to which different types of report quantities and/or different AI model using phases and/or different AI models correspond are identical or different; and
transmitting, by the terminal equipment, a quantized report quantity to the network device.

34. The method according to supplement 33, wherein the types of report quantities include a beam measurement result, a beam prediction result, and an AI model performance metric result.

35. The method according to supplement 33, wherein the AI model using phases include: an AI model inference phase, an AI model training phase, and an AI model performance monitoring phase.

36. The method according to supplement 33 or 34 or 35, wherein the predefined quantization parameter includes at least one of the number of quantization bits, a dynamic range of a value to be quantized, and a quantization step.

37. The method according to supplement 36, wherein the predefined quantization parameter further includes a quantization type, the quantization type including differential quantization and absolute quantization.

38. The method according to supplement 37, wherein quantization parameters of report quantities to which different quantization types correspond are identical or different.

39. The method according to supplement 37, wherein when the quantization type is differential quantization, the predefined quantization parameter further includes the number of report quantities included in a reporting instance.

40. The method according to any one of supplements 33 to 39, wherein the method further includes:
receiving, by the terminal equipment, AI model using phase triggering signaling transmitted by the network device;
and when receiving the triggering signal, quantizing the report quantity according to a predefined quantization parameter corresponding to the AI model using phase triggered by the triggering signal.

41. The method according to supplement 40, wherein the triggering signaling includes type of the report quantity and/or AI model using phase indication information corresponding to the quantization parameter, or reference signal configuration information and/or measurement report configuration information corresponding to the AI model using phase.

42. The method according to supplement 40, wherein the method further includes:
transmitting, by the terminal equipment, an AI model using phase request to the network device, and receiving the AI model using phase triggering signaling transmitted by the network device in response to the request.

43. The method according to any one of supplements 40 to 42, wherein the triggering signaling is periodically transmitted or aperiodically transmitted.

44. The method according to any one of supplements 33 to 43, wherein the triggering signaling is carried by RRC signaling or MAC CE signaling or DCI signaling, and the quantized report quantity is carried by UCI or an MAC PDU.

45. A network device, including a memory and a processor, the memory storing a computer program, and the processor being configured to execute the computer program to implement the method according to any one of Supplements 1 to 16.

46. A terminal equipment, including a memory and a processor, the memory storing a computer program, and the processor being configured to execute the computer program to implement the method according to any one of Supplements 17 to 44.

47. A communication system, including the network device according to supplement 45 and/or the terminal equipment according to supplement 46.

What is claimed is:

1. An information transceiving apparatus, applicable to a network device, the apparatus comprising:
a first transmitter configured to transmit to a terminal equipment a quantization parameter of a report quantity; and
a first receiver configured to receive a report quantity quantized by the terminal equipment according to the quantization parameter.

2. The apparatus according to claim 1, wherein quantization parameters of different types of report quantities are identical or different.

3. The apparatus according to claim 1, wherein quantization parameters of report quantities to which different AI model using phases and/or different AI models correspond are identical or different.

4. The apparatus according to claim 2, wherein the types of report quantity comprise a beam measurement result, a beam prediction result, and an AI model performance metric result.

5. The apparatus according to claim 3, wherein the AI model using phases comprise: an AI model inference phase, an AI model training phase, and an AI model performance monitoring phase.

6. The apparatus according to claim 1, wherein the quantization parameter comprises at least one of the number of quantization bits, a dynamic range of a value to be quantized, and a quantization step.

7. The apparatus according to claim 6, wherein the quantization parameter further comprises a quantization type, the quantization type comprising differential quantization and absolute quantization.

8. The apparatus according to claim 7, wherein quantization parameters of report quantities to which different quantization types correspond are identical or different.

9. The apparatus according to claim 7, wherein when the quantization type is differential quantization, the quantization parameter further comprises the number of report quantities included in a reporting instance.

10. The apparatus according to claim 1, wherein the first transmitter is further configured to transmit type of the report quantity and/or AI model using phase indication information to which the quantization parameter corresponds to the terminal equipment.

11. The apparatus according to claim 1, wherein the first transmitter is further configured to transmit AI model using phase triggering signaling to the terminal equipment.

12. The apparatus according to claim 11, wherein the triggering signaling comprises type of report quantity and/or AI model using phase indication information corresponding to the quantization parameter, or reference signal configuration information and/or measurement report configuration information corresponding to the AI model using phase.

13. The apparatus according to claim 1, wherein the first receiver is further configured to receive an AI model using phase request transmitted by the terminal equipment, and the first transmitter is configured to transmit the AI model using phase triggering signaling to the terminal equipment in response to the request.

14. The apparatus according to claim 11, wherein the quantization parameter is carried in the triggering signaling.

15. The apparatus according to claim 11, wherein the triggering signaling is periodically transmitted or aperiodically transmitted.

16. The apparatus according to claim 1, wherein the quantization parameter and/or the triggering signaling is/are carried by RRC signaling or MAC CE signaling or DCI signaling, and the quantized report quantity is carried by UCI or an MAC PDU.

17. An information transceiving apparatus, applicable to a terminal equipment, the apparatus comprising:
a second receiver configured to receive a quantization parameter of a report quantity transmitted by a network device;
first processor circuitry configured to quantize the report quantity according to the quantization parameter; and
a second transmitter configured to transmit a quantized report quantity to the network device.

18. The apparatus according to claim 17, wherein the second receiver is further configured to receive AI model using phase triggering signaling, and when the second receiver receives the quantization parameter and the triggering signaling, the first processor circuitry quantizes the report quantity.

19. An information transceiving apparatus, applicable to a terminal equipment, the apparatus comprising:
second processor circuitry configured to quantize a report quantity according to a quantization parameter predefined for an AI model using phase or for an AI model or for a type of report quantity, wherein quantization parameters of report quantities to which different types of report quantity and/or different AI model using phases and/or different AI models correspond are identical or different; and
a third transmitter configured to transmit a quantized report quantity to a network device.

20. The apparatus according to claim 19, the apparatus further comprising:
a third receiver configured to receive AI model using phase triggering signaling, and
wherein, when the third receiver receives the triggering signal, the second processor circuitry quantizes the report quantity according to a predefined quantization parameter corresponding to the AI model using phase triggered by the triggering signal.
